(19) United States
(12) Patent Application Publication
(10) Pub. No.: US 2004/0174489 A1
(43) Pub. Date: Sep. 9, 2004

(54) Electronic device and ESD prevention method thereof

(76) Inventor: Chih-Chiang Su, Kaohsiung (TW)

Correspondence Address: QUINTERO LAW OFFICE, 1617 BROADWAY, 3RD FLOOR, SANTA MONICA, CA, 90404, US

(21) Appl. No.: 10/792,366

(22) Filed: Mar. 3, 2004

(30) Foreign Application Priority Data
Mar. 4, 2003 (TW) 92104559

(51) Int. Cl. G02F 1/1345

(52) U.S. Cl. 349/152

(57) ABSTRACT

An electronic device and an ESD prevention method thereof. The electronic device includes a printed circuit board, a liquid crystal display module, and a controller. The printed circuit board includes a ground layer. The liquid crystal display module is disposed on the printed circuit board, and includes a central portion, a surrounding portion, an anti-ESD wire, and a contact. The central portion is surrounded by the surrounding portion, and the anti-ESD wire is disposed on the surrounding portion. The liquid crystal display module wires are located between the anti-ESD wire and the central portion. The contact is coupled to the anti-ESD wire and the ground layer respectively so that an ESD on the liquid crystal display module is ground via the anti-ESD wire and the contact. The controller is disposed on the printed circuit board, and is coupled to the liquid crystal display module. The liquid crystal display module is reset by the controller at a predetermined interval.

### BACKGROUND OF THE INVENTION

1. Field of the Invention

The invention relates to an electronic device and an ESD prevention method thereof, and more particularly, the invention relates to a low-cost ESD prevention method that improves the ESD protection ability of a liquid crystal display module of an electronic device.

2. Description of the Related Art

Recent rapid development of liquid crystal display module technology has resulted in a transition from monochromatic to color displays. Rapid development, however, has many attendant problems.

In an electronic device, the liquid crystal display module is mounted among many other components. Thus, an ESD (electrostatic discharge) from other components may damage the liquid crystal display module. Specifically, when a liquid crystal display module is subject to ESD, its display may be abnormal. For example, the displayed image may disappear, be incomplete, or some lines of the displayed image may disappear.

Traditionally, to prevent ESD, a metal housing is provided on the case of the electronic device so as to protect the liquid crystal display module. The quality of protection provided by the metal housing is, however, inadequate, and the manufacturing cost thereof is increased.

### SUMMARY OF THE INVENTION

In view of this, the invention provides an electronic device with improved ESD protection ability.

Another purpose of this invention is to provide an ESD prevention method that can be adapted to an extremely complicated electronic communication device and prevent damage to the liquid crystal display.

Accordingly, the invention provides an electronic device including a printed circuit board, a liquid crystal display module, and a controller. The printed circuit board includes a ground layer. The liquid crystal display module is disposed on the printed circuit board, and includes a central portion, a surrounding portion, an anti-ESD wire, and a first contact. The central portion is surrounded by the surrounding portion, and the anti-ESD wire is disposed on the surrounding portion. The liquid crystal display module wires are located between the anti-ESD wire and the central portion. The first contact is coupled to the anti-ESD wire and the ground layer respectively so that ESD occurring in the liquid crystal display module is ground via the anti-ESD wire and the first contact. The controller is disposed on the printed circuit board, and is coupled to the liquid crystal display module. The liquid crystal display module is reset by the controller at a predetermined interval.

In a preferred embodiment, the electronic device further includes a first wire connecting the first contact and the ground layer.

In another preferred embodiment, the liquid crystal display module further includes a plurality of second contacts, and the first contact is located outside the second contacts.

Furthermore, the electronic device includes a second wire connecting one of the second contacts and the controller.

In another preferred embodiment, the central portion of the liquid crystal display module is the display region of the liquid crystal display module, and the surrounding portion of the liquid crystal display module is a layout region of the liquid crystal display module.

In another preferred embodiment, the anti-ESD wire is made of indium tin oxide, and the width of the anti-ESD wire is 0.15 mm-0.35 mm.

In this invention, a method for preventing ESD is provided, and includes the following steps. A liquid crystal display module is provided. The liquid crystal display module includes a central portion, a surrounding portion, and an anti-ESD wire. The central portion is surrounded by the surrounding portion, and the anti-ESD wire is disposed on the surrounding portion, and the liquid crystal display module wires are located between the anti-ESD wire and the central portion. The liquid crystal display module is reset at a predetermined interval.

In a preferred embodiment, the method further includes the following step. A level of the liquid crystal display module is returned to a predetermined value so as to reset the liquid crystal display module.

In this invention, a machine-readable storage medium storing a computer program which, when executed, causes a computer to perform a method for preventing ESD is provided. The method includes the following steps. A liquid crystal display module is provided. The liquid crystal display module includes a central portion, a surrounding portion, and an anti-ESD wire. The central portion is surrounded by the surrounding portion, and the anti-ESD wire is disposed on the surrounding portion, the liquid crystal display module wires are located between the anti-ESD wire and the central portion. The liquid crystal display module is reset at a predetermined interval.

### BRIEF DESCRIPTION OF TEE DRAWINGS

The present invention can be more fully understood by reading the subsequent detailed description and examples with references made to the accompanying drawings, wherein:

FIG. 1a is a schematic view of an electronic device as disclosed in the invention;

FIG. 1b is another schematic view of an electronic device as disclosed in the invention;

FIG. 2 is a schematic view of a liquid crystal display module in FIG. 1a; and

FIG. 3 is a flow chart of an ESD prevention method as disclosed in the invention.

### DETAILED DESCRIPTION OF THE INVENTION

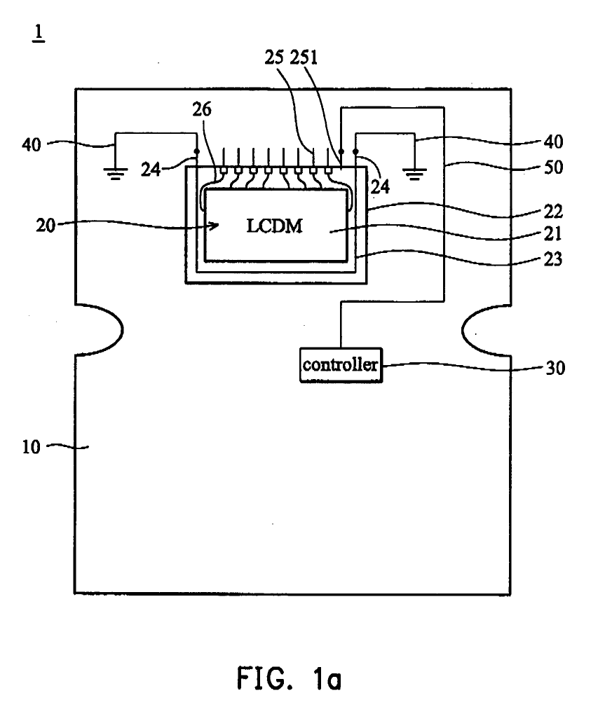

FIG. 1a and FIG. 1b show an electronic device 1 as disclosed in the invention. The electronic device 1 includes a printed circuit board 10, a liquid crystal display module 20, a controller 30, two first wires 40, and a second wire 50. It is understood that the electronic device 1 further includes other components, such as a case. However, since other components are less relevant to this invention, they are not shown in the figures and their description is omitted.

The printed circuit board 10 is a basic component of the electronic device 1, and provides necessary functions required by the electronic device 1. The printed circuit board 10 is a multi-layer board, and includes a ground layer (or a ground surface) 11 therein as shown in FIG. 1b.

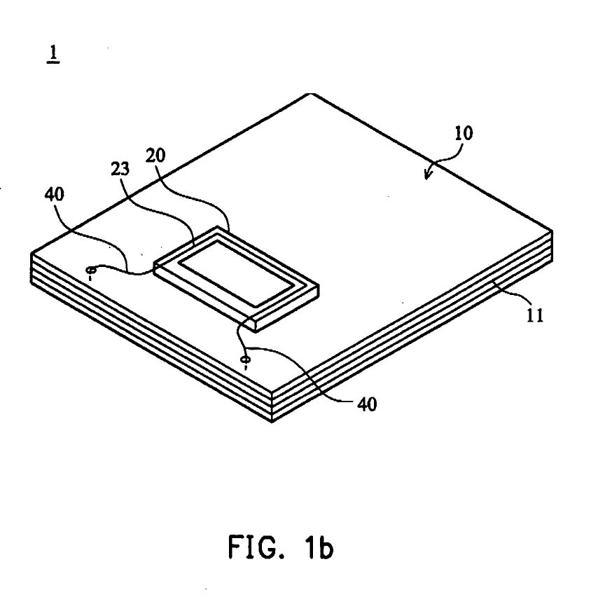

The liquid crystal display module 20 is disposed on the printed circuit board 10, and is divided into a central portion 21 and a surrounding portion 22 as shown in FIG. 2. The central portion 21 is surrounded by the surrounding portion 22, and serves as the display region of the liquid crystal display module 20. The surrounding portion 22 is used as a circuit layout region of the liquid crystal display module 20. That is, the liquid crystal display module 20 can be formed with, for example, an anti-ESD wire 23, two first contacts 24, eight second contacts 25, and a plurality of wires 26 formed on the surrounding portion 22.

The anti-ESD wire 23 is disposed on the surrounding portion 22, and is located at the outermost portion of the liquid crystal display module 20. That is, all of the wires 26 are schemed between the anti-ESD wire 23 and the central portion 21. In addition, it is noted that the anti-ESD wire 23 may be made of indium tin oxide, and the width of the anti-ESD wire 23 may be 0.15 mm-0.35 mm.

The first contact 24 is connected to the anti-ESD wire 23 and the first wire 40, and is coupled to the ground layer 11 via the first wire 40. Thus, ESD in the liquid crystal display module 20 is transmitted to the first contact 24 via the anti-ESD wire 23, and is transmitted to the ground layer 11. Furthermore, it is understood that in this embodiment, the number of first contacts 24 is two, however, in practice, it is not limited to this.

The second contacts 25 are located between the first contacts 24; that is, both first contacts 24 are located outside the second contacts 25. Furthermore, one of the second contacts 25 is a reset contact 251 for receiving a reset single from the controller 30. In addition, it is understood that in this embodiment, the number of second contacts 25 is eight. However, in practice, it is not limited to this.

The controller 30 is disposed on the printed circuit board 10, and is coupled to the liquid crystal display module 20 via the second wire 50. The controller 30 outputs a reset signal at a predetermined interval to return the level of the liquid crystal display module 20 back to a standard value via the reset contact 251. Thus, the image displayed by the liquid crystal display module 20 can be reset and refreshed at a predetermined interval. As a result, damage to the liquid crystal display module 20 due to ESD can be reduced.

The first wire 40 connects the first contacts 24 and the ground layer 11. The second wire 50 connects the controller 30 and the reset contact 251.

The hardware of the electronic device 1 is described as above, and an ESD prevention method thereof is described in the following.

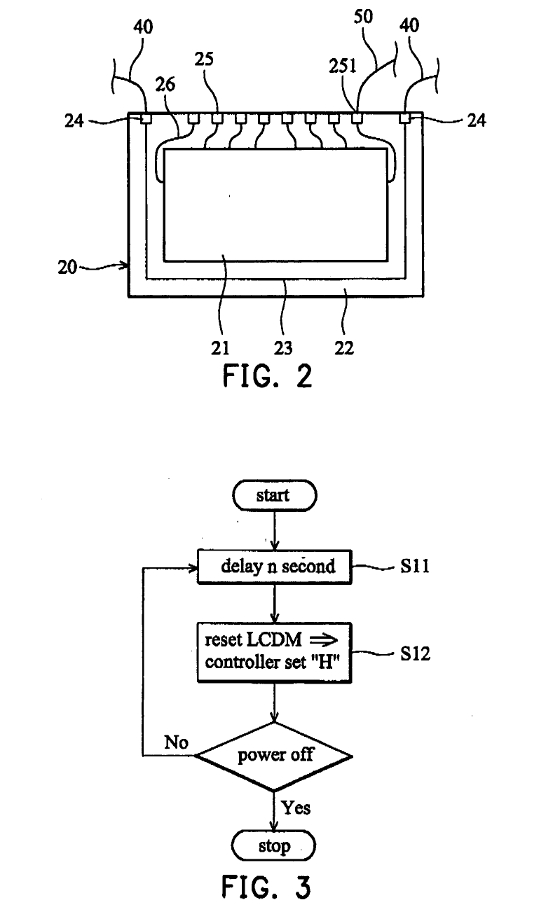

Referring to FIG. 3, the method includes the following steps. First, as shown in step S11 of FIG. 3, the controller 30 outputs a reset signal at a predetermined interval to return the level of the liquid crystal display module 20 back to a standard value, such as “H”. After a delay of seven seconds, for example, the controller 30 outputs a reset signal. Thus, the liquid crystal display module 20 can be reset as shown in the step 12 of FIG. 3. Furthermore, as shown in FIG. 3, the above steps proceed until the electronic device 1 is powered off.

In addition, according to another embodiment of the invention, a machine-readable storage medium storing a computer program which, when executed, causes a computer to perform a method for preventing ESD is provided. The method includes the steps as stated above.

Moreover, based on the EN61000-4-2, IEC1000-4-2, or ETS 300342-1 standards, the ESD prevention ability of the conventional liquid crystal display module and that of the liquid crystal display module as disclosed in the invention are tested.

In Table One, ESD testing of (±2 KV, ±4 KV, ±8 KV, ±15 KV) via an air discharge is performed on the liquid crystal display module of electronic device. In Table Two, ESD testing of (±2 KV, ±4 KV, ±8 KV, ±15 KV) via a contact discharge is performed on the liquid crystal display module of the electronic device.

TABLE ONE

| | After ESD air | |
|---|---|---|
| | discharge test | After reset |
| The | The image displayed | The liquid |
| conventional | by the liquid crystal | crystal display |
| liquid | display module is | module cannot |
| crystal | abnormal; for example, | return to its |
| display | the picture disappears | normal state. |
| module | or is incomplete, or | The liquid |
| | some of the lines of | crystal display |
| | the image disappear. | module cannot |
| | The image of the | display normally. |
| | liquid display module | |
| | cannot be normally | |
| | displayed. | |
| The liquid | The liquid crystal | The liquid |
| crystal | display module is not | crystal display |
| display | damaged by the ESD. | module can display |
| module as | The image displayed | normally. |
| disclosed in | by the liquid crystal | The liquid |
| the invention | display module is | crystal display |
| | abnormal; for example, | module can return |
| | the picture disappears | to its normal |
| | is incomplete, or some | state. |
| | of the lines of the | |
| | image disappear. | |

TABLE TWO

| | After ESD contact | |
|---|---|---|
| | discharge test | After reset |
| The | The image displayed by | The liquid |
| conventional | the liquid crystal | crystal display |
| liquid | display module is | module cannot |
| crystal | abnormal; for example, | return to its |
| display | the picture disappears or | normal state. |
| module | is incomplete, or some of | The liquid |
| | the lines of the image | crystal display |
| | disappear. | module cannot |
| | The image of the liquid | display |
| | display module cannot be | normally. |
| | normally displayed. | |
| The liquid | The liquid crystal | The liquid |
| crystal | display module is not | crystal display |
| display | damaged by ESD. | module can |
| module as | The image displayed by | display |
| disclosed in | the liquid crystal | normally. |
| this | display module is | The liquid |
| invention | abnormal; for example, | crystal display |
| | the image disappears or | module can |
| | is incomplete, or some of | return to its |
| | the lines of the image | normal state. |
| | disappear. | |

As can be seen from the Tables One and Two, regardless of whether the liquid crystal display module is tested by air discharge or contact discharge, the liquid crystal display module as disclosed in the invention attains a better result.

The electronic device and the ESD prevention method as disclosed in the invention possess the following advantages.

The ground contacts located at the outermost portion of the liquid crystal display module transmit ESD in the liquid crystal display module to the ground layer of the printed circuit board via the anti-ESD wire. Additionally, the computer program built in to the controller, enables the liquid crystal display module to receive a control signal at a predetermined interval so that the liquid crystal display module can maintain a normal state. Moreover, as the housing of the liquid crystal display module can be plastic, its weight can be largely reduced. Further, due to the hardware of the electronic device, permanent damage to the liquid crystal display module due to the ESD can be eliminated. Additionally, temporary damage to the liquid crystal display module due to ESD can be reduced by the controller operation of the electronic device.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device comprising:
a printed circuit board including a ground layer;
a liquid crystal display module, disposed on the printed circuit board, including a central portion, a surrounding portion, an anti-ESD wire, and a first contact, wherein the central portion is surrounded by the surrounding portion, and the anti-ESD wire is disposed on the surrounding portion, and wires of the liquid crystal display module are schemed between the anti-ESD wire and the central portion, and the first contact is coupled to the anti-ESD wire and the ground layer respectively so that ESD in the liquid crystal display module is ground via the anti-ESD wire and the first contact; and
a controller, disposed on the printed circuit board and coupled to the liquid crystal display module, for resetting the liquid crystal display module at a predetermined interval.

2. The electronic device as claimed in claim 1, further including a first wire connecting the first contact and the ground layer.

3. The electronic device as claimed in claim 1, wherein the liquid crystal display module further includes a plurality of second contacts, and the first contact is located outside of the second contacts.

4. The electronic device as claimed in claim 3, further including a second wire connecting one of the second contacts and the controller.

5. The electronic device as claimed in claim 1, wherein the central portion of the liquid crystal display module is the display region of the liquid crystal display module.

6. The electronic device as claimed in claim 1, wherein the surrounding portion of the liquid crystal display module is a circuit layout region of the liquid crystal display module.

7. The electronic device as claimed in claim 1, wherein the anti-ESD wire is indium tin oxide.

8. The electronic device as claimed in claim 1, wherein the width of the anti-ESD wire is 0.15 mm-0.35 mm.

9. A method for preventing ESD, comprising:
providing a liquid crystal display module including a central portion, a surrounding portion, and an anti-ESD wire, wherein the central portion is surrounded by the surrounding portion, the anti-ESD wire is disposed on the surrounding portion, and wires of the liquid crystal display module are located between the anti-ESD wire and the central portion; and
resetting the liquid crystal display module at a predetermined interval.

10. The method as claimed in claim 9, further comprising:
making a level of the liquid crystal display module back to a predetermined value so as to reset the liquid crystal display module.

11. The method as claimed in claim 9, wherein the anti-ESD wire is indium tin oxide.

12. The method as claimed in claim 9, wherein the width of the anti-ESD wire is 0.15 mm-0.35 mm.

13. A machine-readable storage medium storing a computer program which, when executed, causes a computer to perform a method for preventing ESD is provided, wherein the method comprises:
providing a liquid crystal display module including a central portion, a surrounding portion, and an anti-ESD wire, wherein the central portion is surrounded by the surrounding portion, the anti-ESD wire is disposed on the surrounding portion, and wires of the liquid crystal display module are located between the anti-ESD wire and the central portion; and
resetting the liquid crystal display module at a predetermined interval.

14. The storage medium as claimed in claim 13, further comprising:
returning a level of the liquid crystal display module to a predetermined value so as to reset the liquid crystal display module.

15. The storage medium as claimed in claim 13, wherein the anti-ESD wire is made of indium tin oxide.

16. The storage medium as claimed in claim 13, wherein the width of the anti-ESD wire is 0.15 mm-0.35 mm.
